(19) United States
(12) Patent Application Publication
(10) Pub. No.: US 2022/0053794 A1
(43) Pub. Date: Feb. 24, 2022

(54) PLANT JERKY

(71) Applicant: Deutsches Institut für Lebensmitteltechnik e.V., Quakenbrück (DE)

(72) Inventors: Volker Lammers, Quakenbrück (DE); Stefanie Komainda, Quakenbrück (DE)

(21) Appl. No.: 17/410,542

(22) Filed: Aug. 24, 2021

(30) Foreign Application Priority Data
Aug. 24, 2020 (DE) 102020210726.2

(51) Int. Cl. A23J 3/22; A23J 1/00; A23J 3/26; A23P 30/20

(52) U.S. Cl. CPC A23J 3/227; A23P 30/20; A23J 3/26; A23J 1/006

(57) ABSTRACT

The invention relates to a method of preparing a mass strand comprising the steps of
mixing a plant-based protein source, optionally glycerol and optionally additives, e.g. natural colorants, to produce a protein mixture,
feeding the protein mixture into the inlet end of an extruder,
feeding water into the extruder,
optionally adding plant-based fat,
wherein the protein mixture in a section of the extruder is heated to a temperature of 110 to 150° C. and is subjected to a pressure that e.g. prevents the formation of steam bubbles,
shaping the protein mass exiting from the extruder by means of a cooling nozzle and depositing a mass strand on a carrier, wherein the cooling nozzle cools the mass strand to a temperature of at maximum 95° C.,
immediately subsequent rolling of the mass strand deposited on the carrier,
drying,
optionally cutting the mass strand,
packaging, preferably in an inert gas atmosphere and/or in a gas-tight package containing an inert gas atmosphere.

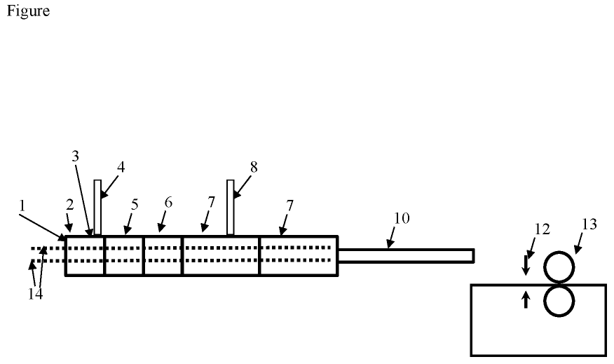

This application claims priority of German patent application 10 2020 210 726.2, filed on 27 Aug. 2020.

The invention relates to a production process for a food of plant-based protein-containing raw materials and to the food produced by means of the process, which food has a firm bite and has a fibrous structure which is preferably similar to the fibrous structure of meat. The process allows for the continuous production of a protein-containing food of plant-based raw materials, which food has a stable shape and a firm bite, can optionally be provided with a coating and/or can be marinated. The food obtainable by the process can form a purely plant-based alternative to dried and seasoned meat strips or resp. meat pieces, which are available as jerky. The process has the advantage of providing a solid food on the basis of plant-based protein that is shelf-stable in a package at room temperature, i.e. unrefrigerated. The package is preferably airtight, in particular sealed against oxygen, and/or contains the food in protective gas, e.g. CO₂ or N₂. The food can be in the form of irregular strips of low height.

WO 2019/143859 A1 describes foods on the basis of plant-based proteins, which foods can contain starch and are produced from an aqueous mixture by extrusion under high temperature and pressure, with subsequent cooling by means of a cooling nozzle, to obtain a meat-like firmness and fibrous structure. The food can subsequently be marinated.

EP 3 270 716 B1 claims a process for the production of a meat substitute product by extrusion of a mixture containing a maximum of 4 wt.-% starch or flour, 40 to 70 wt.-% water and 15 to 35 wt.-% plant-based protein, with additional dosage of 2 to 15 wt.-% fat.

The invention has the object of providing an alternative process for the production of a food on the basis of plant-based raw materials, which food has a firm bite and a fibrous structure, preferably as strips of low height and of irregular shape.

The invention achieves the object by the features of the claims and in particular by a method for producing a mass strand comprising the steps of
mixing one or at least two, preferably at least three, plant-based protein sources, optionally glycerol and optionally additives, e.g. natural colorants, optionally a first portion of water, to produce a protein mixture which is preferably free-flowing, wherein the protein mixture preferably comprises at least 35 to 85 wt.-%, preferably at least 45 wt.-%, more preferably 60 wt.-%, more preferably at least 70 wt.-%, e.g. up to 82 wt.-% or up to 75 wt.-% plant-based protein, optionally mixing plant-based fat, solid or liquid, with the plant-based protein sources to produce a protein mixture,
feeding the protein mixture into the inlet end of an extruder,
feeding water, which can be the total added water or a second portion of water, and optionally additives, e.g. selected from flavorings, smoke flavoring, salt and colorants, into the extruder through a first feed port of the extruder, which first feed port is arranged downstream of the inlet end of the extruder, wherein water is preferably present in a proportion of at maximum 30 wt.-% to 60 wt.-%, e.g. 35 to 55 wt.-%, of the protein mass exiting from the extruder, e.g. water is fed into the extruder in an amount of 30 to 60 wt.-% of the protein mass exiting from the extruder, the remainder being protein mixture and fat, correspondingly at 50 wt.-% water, water and protein mixture are fed into the extruder in equal parts by weight,
optionally feeding plant-based fat, liquid or solid, optionally feeding additives, e.g. flavorings, salt and colorants, into the extruder, preferably in each case downstream of the inlet end, more preferably downstream of the feeding of water, in particular through a second feed port which is mounted on the extruder downstream of the first feed port,
wherein the protein mixture in a section of the extruder is heated to a temperature of 110 to 150° C., preferably 120 to 140° C., and is subjected to a pressure which e.g. prevents the formation of steam bubbles, preferably to a pressure of at least 4 bar or of at least 6 bar, e.g. up to 30 bar, up to 25 bar, up to 28 bar or up to 20 bar,
wherein preferably optionally the extruder in the section upstream of the second feed port is cooled in order to cool the mass to a temperature of at maximum 125° C., e.g. to a temperature of 110° C. or of 115° C. to 122° C. or up to 121° C. or up to 120° C., e.g. 118° C. to 121° C.,
shaping the protein mass exiting from the extruder by means of a cooling nozzle and depositing the protein mass exiting from the cooling nozzle on a carrier, which protein mass exits from the cooling nozzle in the form of a mass strand having a longitudinal extension, wherein the cooling nozzle cools the mass strand to a temperature of at maximum 95° C. and produces a mass strand having a height of 2 mm to 8 mm, e.g. 2.5 mm to 8 mm, e.g. at least 3 or at least 4 mm to at maximum or equal to 6 mm or to at maximum or equal to 5 mm,
immediately subsequent rolling of the mass strand deposited on the carrier, e.g. along the longitudinal extension of the mass strand or at an angle of up to 90°, e.g. 30° to 80°, to the longitudinal extension of the mass strand, to produce rolled mass strands,
optionally, prior to or after rolling, preferably immediately after exiting from the cooling nozzle, dividing the mass strand transversely to the longitudinal extension of the mass strand, e.g. by cutting or breaking, to produce mass strands which are divided, e.g. cut or broken, transversely to the longitudinal extension,
optionally, prior to or after rolling, preferably immediately after exiting from the cooling nozzle, prior to cutting or breaking, optionally applying cut or broken pieces onto the mass strand and/or onto the carrier,
drying, prior to or after cutting or breaking, e.g. drying until marinade has dried up, in particular to a maximum water content of 30 wt.-% or below and/or to an aw value of 0.88 or below, in each case determined for the mass strand,
optionally cutting the mass strand, preferably transversely to its longitudinal extension,
optionally cooling, preferably without additional cooling or cooling by room air only,
packaging, preferably in a protective gas atmosphere in a gas-tight package and/or packaging in a gas-tight package containing a protective gas atmosphere,
preferably pasteurizing after packaging, in particular pasteurizing the cut or broken mass strands having fat or marinade applied thereto in a gas-tight package, or consisting thereof.

Therein, immediately subsequent rolling is a rolling that occurs while the mass strand is cooled to a temperature of not less than 30° C., e.g. at maximum to 70° C. or below, and/or is a rolling that occurs within 5 min or 4 min or within 1 min, 2 min, or 3 min after the mass strand exits from the cooling nozzle. Optionally, the mass strand is free of glycerol.

Generally, the strips can also be referred to as pieces. Preferably, the strips have a maximum height of 3 to 6 mm, while the width is determined transversely to the rolling direction or transversely to the longitudinal extension, and the length is determined along the rolling direction or resp. along the longitudinal extension.

The marinade is preferably dried up when the marinade adheres to the mass strand and is no longer sticky, in particular when the marinade feels dry to the touch and does not adhere to the hand.

The process has the advantage that the mass strand exiting from the extruder or from the cooling nozzle subsequent thereto is formed only by the subsequent rolling and cutting, preferably only by cutting or breaking approximately perpendicularly to its longitudinal extension, so that the process does not have a further step of pressing, optionally a further step of cutting, preferably does not comprise a further step of forming, e.g. does not comprise pressing within a mold. As such, the cooling nozzle at the outlet can e.g. have a gap height of 2 mm or 2.5 mm up to 8 mm, e.g. 2 to 6 mm or up to 5 mm or up to 4 mm, and the process can optionally be carried out without cutting the mass strand along the longitudinal extension.

Optionally, a first portion, e.g. 30 to 70 wt.-%, of the total added water is admixed to the protein mixture prior to feeding into the inlet end of the extruder, preferably including a holding period of e.g. 2 min to 120 min, preferably 5 to 20 min, after admixing the water and prior to feeding into the inlet end of the extruder. Such a holding period results in swelling of the protein mixture, wherein the protein mixture still remains free-flowing.

The total first portion of water, which is added to the protein mixture prior to feeding into the extruder and through the first feed port, preferably also includes glycerol. In this embodiment, the first portion of water and the second portion of water constitute the total mass of added water. Alternatively, the protein mixture can be produced without adding water and the entire water is fed into the extruder only through the first feed port.

For heating the protein mixture in the extruder, preferably the stator of the extruder, optionally alternatively or additionally the screw of the extruder, is heated at least in sections, e.g. by means of a double jacket through which a heat transfer medium flows, or by means of an electric heater. For heating the protein mixture in a section of the extruder to a temperature of 110 to 150° C., preferably 120 to 140° C., preferably sections of the extruder are heated, e.g. in at least two adjacent sections, which each have a higher temperature in the downstream direction and in each case correspondingly heat the protein mass along the flow direction to higher temperatures.

A first section of the extruder, which is adjacent to the inlet end and preferably has a first feed port, can e.g. be unheated or can be heated to a first temperature, and a second section of the extruder adjacent downstream thereto can be heated to a second temperature, higher than the first temperature, and optionally a third section of the extruder, which is adjacent downstream to the second section, can be heated to a third temperature, higher than the second temperature. Accordingly, in a first section of the extruder without heating or with heating, the protein mixture can have a first temperature or can be brought to a first temperature and can be mixed by means of at least one screw, with feeding of water and optionally additives by means of the first feed port, can be heated to a second temperature in the downstream adjacent second section of the extruder, and can be heated to the third temperature in the third section of the extruder, in each case with mixing by means of at least one screw. The third section of the extruder can be followed downstream by a fourth section of the extruder which is cooled and in which the mass is cooled upstream of a second feed port, e.g. to a temperature of 110° C. or from 115° C. to 122° C. or up to 121° C. or up to 120° C., e.g. 118 to 121° C. Downstream from or within a fourth section of the extruder, preferably plant-based fat, liquid or solid, optionally additives, are added to the mass through the second feed port. Downstream of the fourth section, a fifth section of the extruder can follow which can optionally be cooled and in which the mass is further mixed by means of the at least one screw.

Sections of the extruder are preferably arranged in a common stator, which can be composed of segments or which can be single-pieced.

The longitudinal extension of the mass strand is presently the machine direction or resp. the longitudinal extension along which the mass strand exits from the extruder, even if during the optional cutting, the cutting edge is greater than the longitudinal extension of the mass strand along the exit direction or resp. is greater than the machine direction.

The rolling can be carried out by an inherently rigid roller or by a rubber roller, wherein the roller can be rotationally driven or can be run on bearings in a freely rotatable manner. Therein, the circumferential surface of the roller can be cylindrical or can have a relief with heights and depths.

Optionally, the carrier can be formed by a barrel in the area of the rolling, so that the mass strand is loaded between a barrel and a roller during rolling.

The rolling is carried out e.g. down to a reduction in height to 90%, preferably to about 80%, even more preferably to about 75% to 70% of the height that the mass strand has after being deposited on the carrier. Preferably, the rolling is carried out down to a height of 2 to 8 mm or to 7 mm, e.g. to 6 mm, to 5 mm, to 4 mm or to 3 mm. Generally, the rolling can be carried out in one rolling step or in at least two rolling steps.

Optionally, the rolling can be carried out such that the circumferential speed of the roller is equal to the speed of the carrier, or such that the circumferential speed of the roll is higher or lower than the speed of the carrier.

Optionally, the roller is arranged with its rotational axis in parallel to the surface of the carrier and in perpendicular or at an angle of <90°, e.g. at an angle of 30° to 89°, e.g. from 45° to 89°, e.g. 75° to 89°, to the longitudinal extension of the mass strand. Upon arranging the roller with its rotational axis at an angle of <90° to the longitudinal extension of the mass strand and at a circumferential speed of the roller higher or lower than the speed of the carrier, the mass strand is sheared and the structure and surface of the mass strand can be changed. Upon arranging the roller with its axis of rotation at an angle of <90° to the longitudinal extension of the mass strand, the mass strand is preferably cut transversely to its longitudinal extension prior to rolling.

Optionally, the roller can be heated to a temperature, e.g. to a temperature of 70 to 200° C., in order to superficially heat the mass strand, e.g. for superficial forming. Alternatively, the roller can be cooled, e.g. to a temperature of at least 5° C., preferably at least 10° C. or at least 15° C. below the temperature of the mass strand immediately prior to rolling. Such a cooling of the roller can reduce an adhesion of the mass strand to the roller.

Preferably, the cooling nozzle generates a mass strand having a height of at maximum 7 mm, preferably of at maximum 4 mm, e.g. having a height of 2 to 2.5 mm. For production of a mass strand having a height of 4 to 5 mm, the cooling nozzle can e.g. have a gap height at the outlet of 2.5 to 4.5 mm. The cooling nozzle is preferably cooled in order to cool the exiting mass strand to 60 to 90° C., preferably to 70 to 90° C. or to 80° C.

Generally, the mass strand can cool on the carrier, preferably by room air cooling, e.g. to 20° C. or higher, more preferably to 25° C. or higher, e.g. to 30 to 60° C., e.g. to a maximum of 50° C.

Further optionally, prior to rolling, fat or marinade is applied, e.g. sprayed, onto the surface of the roller and/or onto the mass strand. Therein, fat or marinade, which can be aqueous or fatty or an emulsion, can be pressed superficially into the strand, as well as reduce or prevent adhesion of the mass strand to the roller.

Further optionally, fat or marinade is superficially applied, e.g. sprayed, onto at least one surface, preferably at least onto the lower surface, preferably onto the lower and upper surfaces of the mass strand and/or onto the carrier, in an area immediately after the mass strand exits from the cooling nozzle.

Generally preferably, the cooling nozzle is arranged above the carrier and is set up such that the cooling nozzle deposits the mass strand onto the carrier so that the mass strand rests on the carrier with a surface extending in width, and with its height projects above the carrier.

The dividing of the mass strand transversely to its longitudinal extension can be carried out by rotating the mass strand by up to 90° to its longitudinal extension as it is immediately after exiting from the cooling nozzle, in particular on the carrier, and then dividing the mass strand transversely to the longitudinal extension as it was immediately after exiting from the cooling nozzle, or at 90° to the angle of rotation. Optionally, the dividing can be followed by the rolling.

The breaking of the mass strand transversely to its longitudinal extension can e.g. be carried out by moving the mass strand over an edge that is arranged transversely to the longitudinal extension of the mass strand and longitudinally to its direction of movement, preferably with loading of the mass strand prior to and/or after moving over the edge onto the surface of the mass strand that is arranged opposite to the edge. Therein, the loading of the mass strand can be carried out by barrels or punches, in each case preferably spring-loaded or weight-loaded. Optionally, barrels or punches can load the mass strand in that they move against the mass strand in a clocked manner.

It has shown that even when liquid marinade is applied, which preferably takes place after rolling, the mass strand swells only slightly or not at all and its shape is essentially retained.

The process has the advantage that mass strands produced thereby, which have no animal ingredients and whose protein content comes essentially or completely from plant-based ingredients, at least after drying have a consistency or firm bite and a fiber structure that are similar to dried meat. Generally, the mass strands produced according to the invention have a texture, also referred to here as a firm bite, which has a measured value of 10 to 50 N when measured with a texture measuring device, e.g. TA-XT2 (Stable Microsystems, UK), equipped with a Warner-Bratzler geometry. When measuring with the texture measuring device, a V-shaped blade travels at a speed of 2 mm/s through a 2 cm wide sample. Meanwhile, the maximum force required to cut the sample is recorded. A measurement result of 10-50 N has been measured as characteristic for the mass strands according to the invention. Preferably, a total of 10 individual samples are measured and the average value is generated therefrom. A further advantage of the mass strands produced by the process is that they have a rigidity that permits tumbling with liquid marinade, e.g. in a horizontally rotating drum, without the mass strands being fragmented or subject to substantial abrasion. Therein, the marinade can be aqueous or oily or can be an emulsion; alternatively, the marinade can be powdered, e.g. can be a dry mixture with or of spices, e.g. oil, glucose, pepper, paprika, spices, garlic, salt, optionally sugar.

The drying can be carried out at 20° C. or higher, e.g. at at least 20° C., at least 30° C. or at least 40° C., e.g. up to 80° C., preferably 30 to 60° C., optionally in each case at a relative humidity of 50 to 70%, or at room temperature or under cooling, e.g. at 0 to 10° C. or up to 5° C. Preferably, the drying is carried out to an aw value of at maximum or less than 0.88, preferably at maximum or less than 0.85 or at maximum or less than 0.8.

The plant-based protein sources can e.g. be pumpkin seed flour, cereal protein, in particular oat protein, field bean protein, pea protein or sunflower protein. Preferably, the plant-based protein sources are flours, protein concentrates or protein isolates, e.g. flour, protein concentrate, protein isolate from pumpkin seed flour, from field bean, from pea, from sunflower, or protein isolate from cereals. A preferred protein blend consists of pumpkin seed flour (protein content about 60 g/100 g), sunflower protein (protein content about 48 g/100 g) and pea protein (protein content about 82 g/100 g), with a total protein content of 45 to 85 wt.-%, e.g. 78 to 84 wt.-%, preferably 81 wt.-% protein, 6 wt.-% glycerol and additives, e.g. 6 wt.-% tomato blend, 3 wt.-% caramel and 4 wt.-% salt. Generally, the plant-based protein sources can be liquid or preferably powdery.

Additives include flavorings, salt, and colorants, e.g. liquid smoke or smoke flavoring, meat flavoring, caramel colorant, caramel, e.g. liquid or as a powdery instant caramel, tomato paste, tomato blend, plant-based colorants, spices, yeast extract, wherein preferably yeast extract is excluded.

Generally preferably, the mass strand, and optionally preferably the marinade, does not have a thickener, in particular does not have a thickener selected from the group comprising or consisting of carbohydrate polymers, e.g. starch, modified starch, gums, e.g. guaran, guar gum, cellulose, cellulose derivatives, carboxymethyl cellulose, xanthan, pectin, alginate, locust bean gum, carrageenan, and/or carrageen.

The total protein content of the dry protein blend is preferably about 50 wt.-%. In the case of pumpkin seed flour as a component of the protein blend, an additive is preferably instant caramel powder or caramel colorant in a mass sufficient to impart a brown color to the mass strand.

Optionally, the protein blend can contain plant-based fiber, e.g. pea fiber, apple fiber, cereal fiber.

Further optionally, the protein blend can contain added starch, preferably the protein blend does not have added starch but contains only the starch fractions contained in the plant-based proteins, which can be flour, protein concentrate, and/or protein isolate. Optionally, the protein blend contains soy protein and/or wheat gluten, preferably the protein blend is free of soy protein and/or wheat gluten.

The fat can be selected from canola oil, sunflower oil, olive oil, soybean oil, nut oil, cocoa fat, cottonseed oil, sesame oil, milk fat, butter, and/or purified butterfat that is liquid above 20° C. Generally preferably, the fat is liquid above 0° C. and solid at temperatures below 0° C.

The invention is now described in more detail by an example and with reference to the FIGURE, which schematically shows the process and a device suitable for carrying out the process.

The FIGURE shows an extruder 1 having an inlet end 2 for feeding the protein mixture into the extruder 1, adjacent to the inlet end 2 a first section 3 having a first feed port 4 connected thereto, through which first feed port 4 water and additives are introduced. Downstream of the first section 3 there is connected a second section 5 of the extruder 1, which is heated to a second temperature, and downstream thereto there is connected a third section 6 of the extruder 1, which is heated to a third temperature. Downstream of this third extruder section 6 there is connected a fourth extruder section 7 which is cooled, and within or at the end of the fourth extruder section 7 or after it, a second feed port 8 is connected, through which fat and preferably additives containing aroma can be added. Optionally, a fifth extruder section which can also be cooled is connected downstream of the fourth extruder section. Immediately adjacent to the fifth extruder section 9, a nozzle 10 is connected which is preferably a cooling nozzle for cooling the mass. The nozzle 10 forms the mass exiting from the extruder into a mass strand having a height of preferably at maximum 8 mm, which mass strand is deposited onto a carrier 11. A cutting device or a device for breaking 12, e.g. for breaking along an edge, can be provided for dividing the mass strand. In the embodiment shown here, the mass strand is rolled by a roller 13 which is arranged downstream of the cutting device or the device for breaking, so that the mass strand is first divided transversely to its longitudinal axis and the sections resulting therefrom are rolled.

As is preferred, the extruder 1 has two screws 14.

### EXAMPLE: PRODUCTION OF MASS STRANDS ON THE BASIS OF PLANT-BASED PROTEIN

A protein mixture was prepared from 27 wt.-% pumpkin flour, 27 wt.-% pea protein isolate, 27 wt.-% sunflower protein, 6 wt.-% glycerol and as additives 4 wt.-% table salt, 3 wt.-% instant caramel (powdery) and 6 wt.-% spice blend (tomato flavor) were mixed together and fed into the inlet end of a single-screw extruder (e.g. Coperion), preferably of a twin-screw extruder or a planetary roller extruder. In an alternative protein mixture, pumpkin flour was replaced by field bean flour. Therein, the entire protein mixture, namely the plant-based proteins, glycerin, tomato, caramel and salt, was fed into the inlet end of the extruder.

Through a first feed port located downstream shortly after the inlet end, water with admixed smoke flavoring was continuously fed in the same mass portion as the protein mixture, corresponding to 49 wt.-% of the mass strand. Smoke flavoring was present in the water in a proportion of 0.03 to 0.13%.

Through a second feed port located downstream of the first feed port, sunflower oil in admixture with flavor (meat flavor) was added as fat at 2 wt.-% of the mass strand. The mixing ratio of oil to flavor was 1:1.

The protein mixture accounted for 49 wt.-% of the mass strand, the remainder being water and fat present as a mixture with flavor (meat flavor).

The extruder was heated in stages to 140° C. in the downstream adjacent area by means of heatable jacket segments, and cooled in subsequent jacket segments to achieve a mass temperature of at maximum 120° C. A second feed port was connected in a section arranged adjacent to this jacket segment, through which second feed port a mixture of 1:1 wt./wt. sunflower oil with meat flavoring was continuously metered in. The mass exited from the extruder and immediately thereafter passed through a nozzle cooled by means of a cooling jacket, the nozzle having a rectangular outlet cross-section having a height of about 2.5 to 3 mm. The mass exited from the nozzle as a mass strand, had a temperature of about 40 to 80° C. and a height of about 3 to 4 mm, which was achieved by the height of the outlet cross-section of the nozzle depending on the throughput. The thus produced mass strand was first cut into strands about 10 cm long, and by a roller was then rolled transversely to the longitudinal extension of the sections of the mass strand, so that by only one iteration the height was reduced to about 2 to 3 mm in height.

The rolled mass strand was cut transversely along the longitudinal axis with a knife and preferably subsequently coated with marinade (composed of tomato paste, water, oil, cane sugar, pepper, paprika powder) and dried to <30% residual moisture and/or an aw value <0.85, until the marinade adhered primarily to the pieces of the cut mass strand and did not stick to the fingers upon touch.

The pieces of mass strand had a force required to cut of approximately 10-50 N in a subsequent texture measurement by a Warner-Bratzler geometry, and a firm bite and fibrous texture similar to dried meat strips when tasted.

### REFERENCE LIST

1 extruder
2 inlet end
3 first extruder section
4 first feed port
5 second extruder section
6 third extruder section
7 fourth extruder section
8 second feed port
9 fifth extruder section
10 nozzle
11 carrier
12 cutting device or device for breaking
13 roller
14 screw

1. Process for the production of a mass strand comprising the steps of
mixing at least one plant-based protein source, optionally glycerol and optionally additives to produce a protein mixture,
feeding the protein mixture into the inlet end of an extruder,
feeding water and optionally additives into the extruder through a first feed port of the extruder which is located downstream of the inlet end of the extruder,
wherein the protein mixture in a section of the extruder is heated to a temperature of 110 to 150° C. and is subjected to a pressure which prevents the formation of steam bubbles,
shaping the protein mass exiting from the extruder by means of a cooling nozzle and depositing the protein mass on a carrier, which protein mass exits from the cooling nozzle in the form of a mass strand, wherein the cooling nozzle cools the mass strand to a temperature of at maximum 95° C. and produces a mass strand having a height of at maximum 8 mm,
immediately subsequently rolling the mass strand deposited on the carrier to produce rolled mass strands, and
dividing the mass strand prior to or after rolling,
drying the mass strand, and subsequent
packaging.

2. Process according to claim 1, comprising a step of pasteurizing the mass strands which are packed in gas-tight packages.

3. Process according to claim 1, comprising a step of dividing the mass strand immediately after it exiting from the cooling nozzle transversely to the longitudinal extension of the mass strand.

4. Process according to claim 1, wherein after packaging, the gas-tight packages having mass strands packaged therein are pasteurized.

5. Process according to claim 1, wherein the plant-based protein sources are powdery.

6. Process according to claim 1, wherein the carrier in the area of rolling is formed by a barrel, so that the mass strand during rolling is loaded between a barrel and a roller.

7. Process according to claim 1, wherein the rolling is carried out to a reduction in height to 90% to 70% of the height which the mass strand has after being deposited on the carrier.

8. Process according to claim 1, wherein fat or marinade is applied to the mass strand and/or to the carrier prior to or after rolling.

9. Process according to claim 1, wherein the rolling is carried out by a roller whose circumferential speed is higher or lower than the speed of the carrier, and/or by a roller whose axis of rotation is arranged in parallel to the surface of the carrier and at an angle of <90° to the longitudinal extension of the mass strand.

10. Process according to claim 1, wherein the extruder is a twin screw extruder or a planetary roller extruder.

11. Process according to claim 1, wherein fat or marinade is applied to the mass strand immediately after it exiting from the cooling nozzle.

12. Process according to claim 1, wherein the mass strand after applying marinade is dried until the marinade has dried up.

13. Process according to claim 1, wherein plant-based fat, solid or liquid, is added to the protein mixture prior to feeding the protein mixture into the inlet end of the extruder.

14. Process according to claim 1, wherein the protein mixture contains at least 45 wt.-% plant-based protein.

15. Process according to claim 1, wherein a first portion of the water is admixed to the protein mixture prior to feeding into the inlet end of the extruder, and a second portion of the water is fed through the first feed port, wherein the sum of the first portion and the second portion of water accounts for 35 to 55 wt.-% of the mass strand.

16. Process according to claim 1, wherein additives flavoring, salt and/or colorants are fed through the first feed port and/or through a second feed port which is arranged on the extruder downstream of the first feed port.

17. Process according to claim 1, wherein plant-based fat, liquid or solid, optionally additives, are added through a second feed port which is arranged on the extruder downstream of the first feed port.

18. Process according to claim 16, wherein the extruder is cooled in the section located immediately upstream of the second feed port in order to cool the mass to a temperature of at maximum 125° C.

19. Process according to claim 1, wherein the pressure to which the protein mixture is subjected in a section of the extruder when heated to a temperature of 110 to 150° C. is 4 bar to 30 bar.

20. Mass strand, obtainable by a process according to claim 1, wherein the mass strand has a fibrous structure in parallel to its longitudinal extension and has a firm bite.

21. Device for use in a process according to claim 1, comprising an extruder having an inlet end for feeding a protein mixture, having a first extruder section adjacent to the inlet end with a first feed port connected thereto for feeding water and additives, a second extruder section adjacent downstream thereto which is heated, a third extruder section adjacent downstream thereto which is heated, a fourth extruder section adjacent downstream thereto which is cooled, a second feed port connected thereto for adding fat and additives, a nozzle directly connected thereto which is a cooling nozzle for cooling the mass, a carrier for depositing the mass strand exiting from the nozzle, and a cutting device or a breaking device for dividing the mass strand, and rolled by a roller which is arranged downstream or upstream of the cutting device or breaking device and which is set up to cut the strand transversely to its longitudinal axis.

22. Device according to claim 21, wherein the nozzle is arranged to form the mass exiting the extruder into a mass strand of a maximum height of 6 mm.

23. Device according to claim 21, wherein the roller is set up to reduce the height of the mass strand to 2 to 8 mm and/or to at maximum 90% of the height which the mass strand has immediately after exiting from the nozzle.
